(19) United States
(12) Patent Application Publication
(10) Pub. No.: US 2024/0217030 A1
(43) Pub. Date: Jul. 4, 2024

(54) LASER PROCESSING METHOD

(71) Applicant: TOYOKOH Co.,Ltd., Shizuoka (JP)

(72) Inventors: Yoshiaki SUIZU, Shizuoka (JP); Manabu HARAGUCHI, Shizuoka (JP)

(21) Appl. No.: 18/610,573

(22) Filed: Mar. 20, 2024

Related U.S. Application Data
(63) Continuation of application No. PCT/JP2022/041476, filed on Nov. 8, 2022.

(30) Foreign Application Priority Data
Nov. 9, 2021 (JP) 2021-182318

(51) Int. Cl. B23K 26/0622; B23K 26/082; B23K 26/352; B23K 26/36

(52) U.S. Cl. CPC B23K 26/0622; B23K 26/082; B23K 26/3576; B23K 26/3584; B23K 26/36

(57) ABSTRACT

A surface processing method is for removing a surface of a processing object by moving a laser beam spot with respect to the processing surface, where the beam spot is formed by condensing a continuous wave laser beam on an irradiation surface of the processing object. An irradiation time length is 20 μ-second or less when the beam spot passes through one point on the irradiation surface. A relative speed of the beam spot to the irradiation surface is 3 m/s or more.

### CROSS-REFERENCE TO RELATED APPLICATIONS

This application is a continuation application of International Patent Application No. PCT/JP2022/041476 filed on Nov. 8, 2022, which claims priority to Japanese Patent Application No. 2021-182318 filed on Nov. 9, 2021, the entire contents of which are incorporated by reference.

### TECHNICAL FIELD

The present invention relates to a surface processing method for removing a part of the surface of a processing object by irradiating it with a laser beam.

### BACKGROUND OF THE INVENTION

For example, as a pretreatment before painting on to a steel structure, there is proposed that, rust, oxide film (so-called black scale), old paint film, etc. formed on the surface are removed by irradiating and scanning with a laser beam.

For example, in Patent Document 1, there is described that, on the surface of a metal product, etc., the irradiation position with a laser beam is scanned while rotating it in an arc shape at high speed, and the old coating film before repainting and foreign substances such as rust are removed (cleaned).

In Patent Document 2, there is described that, in the technique of Patent Document 1, a heat-affected layer such as an oxide film is formed on the surface of the processing object by receiving heat from the laser beam and weather resistance, rust resistance, etc. of the object may be adversely affected. And there is also described that, in order to solve this problem, after the first laser irradiation step for removing attached substances such as rust or coating film layer, the second laser irradiation step is performed while changing irradiation parameter with lower heat input into a unit area, thus, a part of the heat-affected layer formed in the first laser irradiation step is removed.

### Prior Art Reference

### Patent Document

Patent document 1: International Publication WO2013/133415
Patent document 1: JP-A-2019-76915

### SUMMARY OF THE INVENTION

### Problem to be Solved by the Invention

In the technique described in Patent Document 2, it is possible to reduce a heat-affected layer such as an oxide film remaining on the surface of the processing object after laser irradiation. However, in this case, it is necessary to perform irradiation with different irradiation parameters at least twice, which requires an increase in the number of times of irradiation and an operation to change the parameters of the irradiation apparatus, which complicates the process.

In order to prevent the formation of an oxide film, etc., it is conceivable to irradiate the laser beam with a low energy density from the start of process, but in this case, the removal efficiency of rust and old paint film is impaired, and the process speed is lowered.

In view of the problems described above, an object of the present invention is to provide a surface processing method that suppresses formation of an oxide film while ensuring removal performance of the surface of the processing object by a simple process.

### Means for Solving the Problem

In order to solve the above-described problems, a surface processing method according to one aspect of the present invention is a surface processing method for removing a surface of a processing object by moving a beam spot with respect to the processing surface, the beam spot being formed by condensing a continuous wave laser beam on an irradiation surface of the processing object, wherein an irradiation time length is 20 μ-second or less when the beam spot passes through one point on the irradiation surface, and a relative speed of the beam spot to the irradiation surface is 3 m/s or more.

According to this, by setting the local irradiation time to 20 μs or less for one point on the irradiated irradiation surface during one pass of the beam spot, without excessively reducing the energy density at the time of irradiation at the sacrifice of the removal efficiency of the processing object, formation of an oxide film can be effectively suppressed.

In addition, by moving the beam spot formed by the continuous wave laser beam with respect to the irradiation surface so that the relative speed with respect to the irradiation surface is 3 m/s or more, with a laser beam output of the oscillator that is realistically required for the process, it becomes possible to prevent the fluence in the irradiated surface from becoming excessively high, thus improving process quality. And at the same time, it becomes possible to shorten the time required for the beam spot to scan the area of the irradiation surface (process time).

In the present specification and claims, the continuous wave (CW) laser light is not limited to being continuously emitted throughout the surface processing steps, but may be intermittently emitted or on-off emission. For example, when the beam spot moves along a predetermined scanning pattern on the irradiation surface, it is possible to have a configuration in which the emission is interrupted in some part of the scanning pattern. Such aspect shall be included in the scope of the present invention.

Further, the continuous wave laser light means a laser light whose continuous emission time is longer than at least the time for the beam spot to pass through a predetermined point on the irradiation surface (beam spot transit time). As long as this definition is satisfied, a quasi-continuous wave (QCW) using a pulsed laser whose pulse width is larger than the beam spot transit time is also included in the continuous wave of the present invention.

In the present invention, the beam spot may be circulated along a predetermined scanning pattern on the irradiation surface, and, the scanning pattern may be moved relative to the irradiation surface.

Further, in the present invention, the scanning pattern may be a circle, and the beam spot may be rotated along the circle.

According to this, the irradiation time and the moving speed of the beam spot can be appropriately set by adjusting the size of the scanning pattern (the diameter of the turning circle) and the rotation speed (turning speed).

Also, the beam spot can be easily scanned over a wide area.

In the present invention, when the scanning pattern is relatively moved with respect to the irradiation surface, the width of the scanning pattern orthogonal to the direction of relative movement may be 10 mm or more.

When attempting to irradiate a wide area efficiently, it is desirable to reduce the overlap in the width direction of the band-shaped region through which the beam spot passes while circling along the scanning pattern. If the width of the scanning pattern (the diameter of the turning circle in case that the scanning pattern is a circle) is small, especially when the irradiation head is hand-held, the ratio of overlap with respect to the width of the scanning pattern tends to increase due to ununiformity in operation, and process efficiency may deteriorate.

According to the present invention, by ensuring the width of the region through which the scanning pattern passes, such deterioration in process efficiency can be suppressed.

In the present invention, when number of passes, which is number of times that the scanning pattern is repeatedly moved along the irradiation surface so that a same region of the irradiation surface is irradiated in a superimposed state, is set to 3 or more, an energy to be applied to the irradiation surface may be set so that an area on which objects to be removed remain is 5% or less of the entire surface on the irradiation surface.

According to this, for example, when irradiation is performed for a predetermined number of passes, although, the surface to be removed (typically, rust or old paint film left behind) remains, one additional pass of irradiation should be performed. On such occasion, extension of process time due to additional irradiation can be suppressed. (For example, if 1 pass was originally planned and 1 pass of additional irradiation is required, the irradiation time will be approximately doubled. But, if 3 passes were originally planned, and 1 pass of additional irradiation shall be performed, the irradiation time length is only about 1.3 times.)

Further, in the present invention, when number of passes, which is number of times that the scanning pattern is repeatedly moved along the irradiation surface so that the same region of the irradiation surface is irradiated in a superimposed state, may be set to 20 or less, an energy to be applied to the irradiation surface is set so that the area on which objects to be removed remain is 5% or less of the entire surface on the irradiation surface.

According to this, it is not necessary to repeat the irradiation excessively, and it is possible to suppress the process from becoming complicated.

In the present invention, 1-point fluence, which is energy per unit area given to the irradiation surface when the beam spot passes through one point on the irradiation surface, may be set to 100 J/cm² or less.

According to this, it is possible to suppress the generation of scattered matter such as spatters, and to protect the optical system and protective glass of the irradiation head.

In the present invention, the configuration is such that the 1-point fluence, which is energy per unit area given to the irradiation surface when the beam spot passes through one point on the irradiation surface, may be set to 27 J/cm² or more.

According to this, when the object to be removed is rust generated on the irradiation surface, the rust can be surely crushed and removed.

Further, even when the laser beam is further irradiated after finishing the rust removal, it is possible to suppress the formation of a bluish to blackish oxide film over a wide range of the irradiation surface.

In the present invention, the 1-point fluence, which is the energy per unit area given to the irradiation surface when the beam spot passes through one point on the irradiation surface, may be set to 31 J/cm² or more.

According to this, even when the laser beam is further irradiated after the rust removal is completed, it is possible to suppress the formation of bluish to blackish oxide films which scatters on the irradiation surface.

In the present invention, the surface roughness of the irradiation surface after irradiation with the laser beam may be set to 25 μm Rz JIS or more.

According to this, when painting is applied to the irradiation surface after irradiation, the surface roughness can be used to generate an anchor effect between the paint film, thus the adhesiveness to the paint film can be improved.

In the present invention, the surface roughness of the irradiation surface after irradiation with the laser beam may be set to 80 μm Rz JIS or less.

According to this, it is possible to prevent the thickness of the painting film from becoming insufficient at the convex portions of the uneven shape of the irradiated surface, and to ensure the painting quality.

In the present invention, the base material of the processing object can be made of an iron-based metal.

According to this, hydroxides such as rust and oxides such as Fe 2 O 3 and Fe 3 O 4 are crushed and effectively removed by the heat input from the laser beam. And also, new formation of them by the heat input can be suppressed.

In the present invention, the surface removed from the processing object by irradiation with the laser beam comprises at least one of an oxide, hydroxide, carbonate, paint film or salinity of the base material of the processing object or a material of a paint film formed on the surface of the base material.

### Effect of the Invention

As described above, according to the present invention, it is possible to provide a surface processing method that suppresses the formation of an oxide film while ensuring the removal performance of the surface of the processing object by a simple process.

### BRIEF DESCRIPTION OF THE DRAWINGS

FIG. 1 is a cross-sectional view of an irradiation head used in an embodiment of a surface processing method to which the present invention is applied.

FIG. 2 is a schematic diagram which shows the scanning state of the laser beam of the processing object surface in the surface processing method of embodiment.

FIG. 3 is a figure explaining the concept of the lap ratio in the surface processing method of embodiment.

FIG. 4 are pictures which show examples of the oxide film formation state of the processing object surface after a laser irradiation process.

FIG. 5 is a graph which shows the correlation between irradiation time and power density, and formation of an oxide film.

FIG. 6 is a diagram schematically showing a state of overlap of turning circle passing areas in the embodiment.

FIG. 7 are pictures showing examples of spatters scattering state during laser irradiation.

FIG. 8 is a graph which shows the correlation with the 1-point fluence and the evaluation result of spatters amount.

FIG. 9 is a schematic cross-sectional view of a surface portion of a processing object which is painted after laser irradiation.

FIG. 10 is a figure which shows a definition of defocus at the time of laser irradiation.

FIG. 11 is pictures showing examples of the state of oxide film formation on the processing object surface after laser irradiation processing. In these pictures, evaluation values 2 to 4 are added in addition to the data of FIG. 4.

### MODE FOR CARRYING OUT THE INVENTION

An embodiment of a surface processing method to which the present invention is applied will be described below.

In the surface processing method of the embodiment, by using a laser irradiation apparatus, the object O is irradiated with a laser beam supplied from a laser oscillator through a fiber, and the irradiation point (beam spot BS) scans the surface of the object O in a circumferential scanning pattern.

The processing object O is, for example, a structure made of ferrous metal such as general steel or stainless steel.

On the surface of the processing object O, there may be compounds such as rust, oxide film, etc., which are obtained by altering or denaturing the base material.

In addition, a film may be formed on the surface of the processing object O by, for example, painting or plating.

Further, oxides, hydroxides, carbonates, and the like of the base material or coating such as plating may be formed on the surface of the processing object O.

Furthermore, the surface of the processing object O may have externally-derived deposits such as salt, scale, and dirt.

In this specification and the scope of claims, the surface portion of the processing object O includes these all.

In the cleaning process, which is the surface processing of the present embodiment, the irradiation point (beam spot BS) on the surface of the processing object O is rotated along a relatively large circumference (turning circle) having a diameter of 10 mm or more, for example. This laser processing cleans the old coating film (coating film to be peeled off), various films such as oxide film, dust, rust, soot and the like constituting the surface portion of the processing object O.

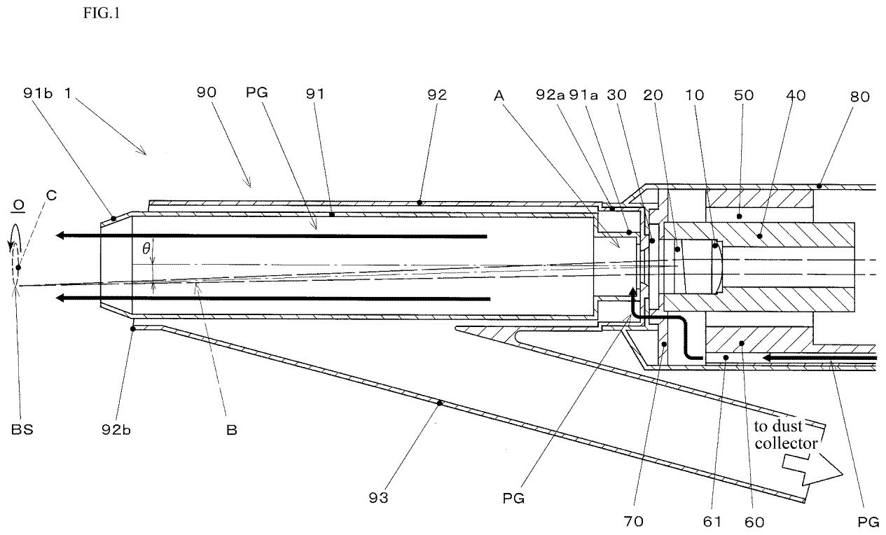

FIG. 1 is a cross-sectional view of an irradiation head used in the surface processing method of the embodiment.

The irradiation head 1 irradiates a processing object with a continuous wave (CW) laser beam B transmitted from a laser oscillator (not shown) through a fiber (not shown).

The irradiation head 1 is, for example, a handy type that can be carried by an operator for irradiation work, but it is also possible to attach the irradiation head 1 to a robot that can move along a predetermined path.

Alternatively, the processing object O may be displaced relative to the irradiation head while the irradiation head 1 is fixed.

The irradiation head 1 includes a focus lens 10, a wedge prism 20, a protective glass 30, a rotary cylinder 40, a motor 50, a motor holder 60, a protective glass holder 70, a housing 80, a duct 90, and the like.

The focus lens 10 is an optical element into which the laser beam B transmitted from the laser oscillator to the irradiation head 1 via the fiber enters after passing through a collimator lens (not shown).

A collimating lens is an optical element that forms (collimates) the laser light emitted from the end of the fiber into a substantially parallel beam.

The focus lens 10 is an optical element that condenses (focuses) the laser beam B emitted by the collimating lens at a predetermined focal position.

As the focus lens 10, for example, a convex lens having positive power can be used.

Incidentally, a beam spot BS, which is an irradiated portion on the surface of the processing object O by the laser beam B, is arranged on a coincident point of the focal point or in a proximity state within the depth of focus (focusing state), or away from the focal position (defocused state).

The depth of focus means a range in the optical axis direction in which the beam diameter is equal to or less than the diameter of a predetermined permissible circle of confusion.

The wedge prism 20 is an optical element that deflects the laser beam B emitted by the focus lens 10 by a predetermined deflection angle θ (see FIG. 1) to make the optical axis angles of the incident side and the exit side different.

The wedge prism 20 is formed in a plate shape in which the thickness thereof is continuously changed so that one of the thicknesses in the direction perpendicular to the optical axis direction of the incident side becomes larger than the thickness of the other.

The protective glass 30 is an optical element made of flat glass or the like and positioned close to the wedge prism 20 on the focal position side (processing object O side, beam spot BS side) along the optical axis direction.

The protective glass 30 is a protective member that prevents foreign matter such as spatters, peeled materials, and dust scattered from the processing object O side from adhering to other optical elements such as the wedge prism 20.

The protective glass 30 is an optical element positioned closest to the focal position along the optical axis direction in the optical system of the irradiation head 1, and is exposed to the processing object O side via a space portion A and an interior of the duct 90, which will be described later.

The focus lens 10, the wedge prism 20, and the protective glass 30 are formed by coating a surface of a member made of a transparent material such as an optical glass, for example, with a surface coating for preventing reflection and surface protection.

The rotary cylinder 40 is a cylindrical member that holds the focus lens 10 and the wedge prism 20 on the inner diameter side.

The rotary cylinder 40 is formed concentrically with the optical axis of the focus lens 10 and the optical axis of the laser beam L which enters to the focus lens 10 (optical axis of the collimating lens).

The rotary cylinder 40 is rotatably supported by a bearing (not shown), with respect to the housing 80, around a rotation center axis coinciding with an optical axis of the focus lens 10.

The rotary cylinder 40 is formed of, for example, a metal such as an aluminum-based alloy, an engineering plastic or the like.

The motor 50 is an electric actuator which rotationally drives the rotary cylinder 40 around a rotation center axis with respect to the housing 80.

The motor 50 is configured, for example, as an annular motor that is concentric with the rotary cylinder 40 and is provided on an outer diameter side of the rotary cylinder 40.

A rotor (not shown) of the motor 50 is fixed to the rotary cylinder 40.

The motor 50 is controlled by a motor drive section (not shown) such that the rotational speed of the rotary cylinder 40 substantially coincides with a desired target rotational speed.

By maintaining a posture of an irradiation head 1 so that a rotation center axis of the rotary cylinder 40 is orthogonal to a surface near an irradiated portion of a processing object O, and by rotating the wedge prism 20 together with the rotary cylinder 40 by the motor 50, thus, the beam spot BS is circularly scanned along the surface of the processing object O in an arc shape around the rotation center axis of the rotary cylinder 40.

When the irradiation head 1 is moved translationally along the surface of the processing object O in this state, the beam spot BS scans the surface of the object O while rotating in a circular shape (an arc shape).

Accordingly, when attention is paid to an arbitrary point on the irradiation object O, the laser beam L is incident intermittently only for a short time, and rapid heating and rapid cooling sequentially occur in a short time.

At this time, the surface portion of the processing object O is crushed and scattered.

The motor holder 60 is a support member that holds a stator (not shown) of the motor 50 at a predetermined position.

A body portion of the motor holder 60 is formed in a cylindrical shape and is fixed while being inserted into the inner diameter side of the housing 80.

The inner peripheral surface of the motor holder 60 is arranged to face the outer peripheral surface of the motor 50 and is fixed to the stator of the motor 50.

In a part of the space between the outer peripheral surface and the inner peripheral surface of the motor holder 60, a purge gas passage 61 through which the purge gas PG flows is formed so as to penetrate the motor 50 in the axial direction.

The purge gas PG is a gas ejected to the processing object O side from a space A when the irradiation head 1 is used (at the time of irradiation). The space A is inside the inner cylinder 91 of the duct 90 to be described later. The space A is also in contact with the surface of the protective glass 30 on the processing object O side.

The purge gas PG has a function of preventing debris such as spatters, dust, foreign matter, etc. scattered from the processing object O side from flying into the housing 80 and adhering to the protective glass 30.

The protective glass holder 70 is a member fixed to the inner diameter side of the housing 80 in a state of holding the protective glass 30.

The protective glass holder 70 is, for example, shaped like a disc with a circular opening in the center.

The laser beam B passes through the opening from the wedge prism 20 side to the processing object O side.

A concave portion into which the protective glass 30 is fitted is formed in the surface portion of the protective glass holder 70 on the processing object O side.

The protective glass 30 is held inside the housing 80 while being fitted in this concave portion.

The protective glass 30 is detachably attached to a protective glass holder 70 so that it can be replaced in the event of contamination or burning.

The surface portion of the protective glass holder 70 on the side opposite to the processing object O side is arranged to face the end surface of the motor holder 60 on the processing object O side with a gap through which the purge gas PG flows.

The housing 80 is a cylindrical member that constitutes the housing of the main body of the irradiation head 1.

In the inside of the housing 80, the focus lens 10, the wedge prism 20, the protective glass 30, the rotary cylinder 40, the motor 50, the motor holder 60, the protective glass holder 70, etc. which were mentioned above are accommodated. Also, an end on the irradiation head 1 side of the fiber and the collimate lens, which is not illustrated, are accommodated.

The duct 90 is a double cylindrical member that protrudes from the end of the housing 80 on the object O side.

The duct 90 has an inner cylinder 91, an outer cylinder 92, a dust collector connection cylinder 93, and the like.

The motor holder 60, the protective glass holder 70, and the housing 80 described above are made of, for example, a metal such as an aluminum-based alloy, engineering plastic, or the like.

The inner cylinder 91 is formed in a cylindrical shape.

The laser beam B passes through the inner diameter side of the inner cylinder 91 and is emitted to the processing object O side.

At the end of the inner cylinder 91 on the housing 80 side, a small-diameter portion 91a is formed in a stepped shape with a smaller diameter than the other portions.

A purge gas PG is introduced from the inside of the housing 80 into the space A inside the small diameter portion 91a.

A tapered portion 91b is formed at the end of the inner cylinder 91 on the side of the processing object so that the diameter of the inner cylinder 91 becomes smaller on the side of the processing object.

The tapered portion 91b has a function of allowing the passage of the laser beam B and increasing the flow velocity by narrowing down the flow of the purge gas PG.

The outer cylinder 92 is a cylindrical member arranged concentrically with the inner cylinder 91 and provided on the outer diameter side of the inner cylinder 91.

Between the inner peripheral surface of the outer cylinder 92 and the outer peripheral surface of the outer cylinder 91, a continuous gap is formed over the entire circumference.

At the end of the outer cylinder 92 on the housing 80 side, a small-diameter portion 92a is formed in a stepped shape with a smaller diameter than the other portions.

The small diameter portion 92a is fixed in a state of being fitted into the end portion of the housing 80 on the processing object O side.

An edge of an end 92b of the outer cylinder 92 on the processing object O side is formed to be inclined with respect to a rotation center axis of rotation of the rotary cylinder 40, so that an upper side becomes a housing 80 side relative to the lower side at the time of normal use of irradiation with the rotation center axis of the rotary cylinder 40 being horizontal.

The dust collecting device connecting cylinder 93 is a cylindrical tube body which protrudes from the outer cylinder 92 toward the outer diameter side, and is connected to the inner diameter side of the outer cylinder 92 in the vicinity of the end on the irradiation object O side of the outer cylinder 92 and in a state of communicating with the inner diameter side of the outer cylinder 92.

The dust collector connection tube 93 is provided below the outer tube 92 during normal use as described above.

The other end of the dust collector connection tube 93 is connected to a dust collector 140, which will be described later, and is vacuum-sucked so that the inside becomes negative pressure.

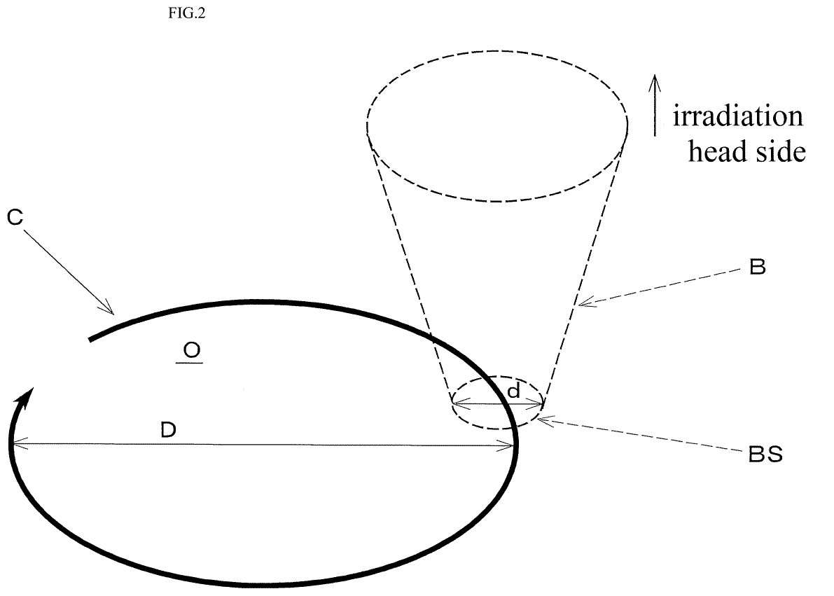

FIG. 2 is a schematic diagram showing a scanning state of a laser beam on the surface of a processing object in the surface processing method of the embodiment.

In this embodiment, by rotating the rotary cylinder 40 and the wedge prism 20 while emitting the laser beam B, the beam spot BS circumferentially turns along a turning circle C (scanning pattern in the embodiment) which has a predetermined diameter (rotational diameter) D along the surface of the processing object.

In this state, the irradiation head 1 is moved relatively and translationally along the surface of the processing object, thus, it is possible to perform processing in which the beam spot BS scans the surface of the processing object in a state that the turning circle C moves on the irradiation surface at a predetermined speed.

In the embodiment, irradiation parameters to be set during process include, for example, the followings.

(1) Laser oscillator output (W): This is set by selecting the model of the laser oscillator and the output adjustment function of the laser oscillator.

(2) Power density (W/cm²): An index indicating how much the laser output is concentrated on the surface (irradiation surface) of the processing object O, and is expressed by the following formula.

$$\begin{matrix}Power density ( W / {cm}^{2} ) & = Output ( W ) / Area of beam spot B S ( {cm}^{2} ) \\ & = Output ( W ) \div ( {( beam spot diameter d ( cm ) / 2 )}^{2} \times π\end{matrix}$$

(3) Turning diameter D (cm) of turning circle C of beam spot BS: set by focal length of focus lens 10, deflection angle θ of wedge prism 20, distance between irradiation head 1 and processing object O (working distance) and so on.

(4) Number of rotations N (rpm) of beam spot BS

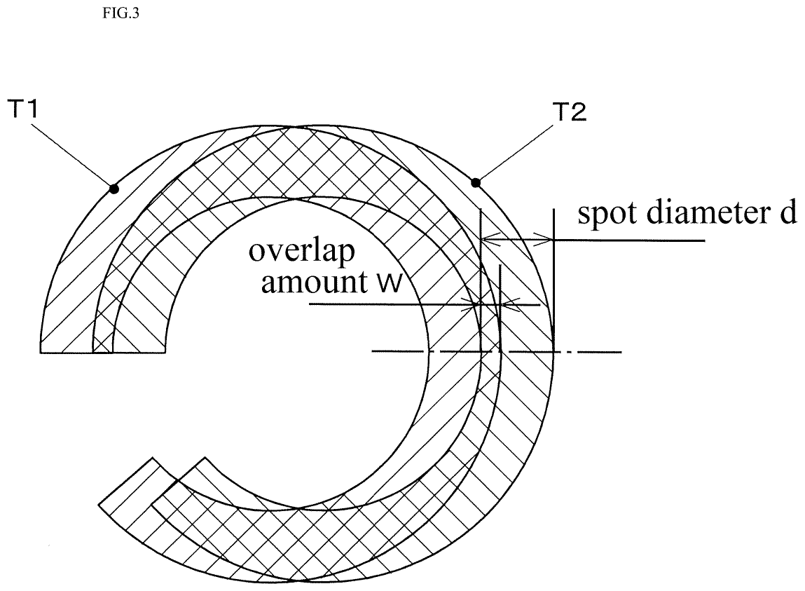

FIG. 3 is a diagram explaining the concept of the lap ratio in the surface processing method of the embodiment.

(5) Lap ratio: When the beam spot BS turns (orbits) along the turning circle C and the center of the turning circle C is moved relative to the processing object O, lap ratio is a value that indicates the overlapping rate of the first passing trajectory T1 of the beam spot BS along the turning circle C and the second passing trajectory T2 formed subsequent to the first passing trajectory T1, that is the overlapping rate of beam spot BS.

The lap ratio is expressed by the following formula using an overlap amount W that indicates the overlap width (length) with respect to the spot diameter d in the width direction perpendicular to the turning direction.

Lap ratio (%)=overlap amount W/spot diameter d of beam spot BS×100.

(6) Turning circle moving speed Vm (mm/s): Relative moving speed (scanning pattern moving speed) of the center of the turning circle C with respect to the irradiated surface on the irradiated surface of the object O.

Here, when the irradiation head 1 is moved translationally and parallel to the irradiation surface while the central axis of rotation of the wedge prism 20 is maintained perpendicular to the irradiation surface, the turning circle movement speed coincides with the operation speed of the head (feed speed, translationally moving speed).

(7) Irradiation time Tp (seconds) of the beam spot BS: when the beam spot BS passes through a one point on the irradiation surface one time, the time length during which this point is irradiated. It is the maximum time length of radiation passing through the one point.

$$Irradation time Tp ( seconds ) of beam spot B S = spot diameter d of beam spot B S \div ( turning diameter D of turning circle C \times π \times ( turning speed N / 60 ) )$$

(8) 1 point fluence (J/cm²): An index indicating the energy per area given to a point when the beam spot BS passes through the point on the irradiation surface one time. It is expressed by the following formula.

$$\begin{matrix}1 point fluence ( J / {cm}^{2} ) & = power density \times irradation time Tp ( seconds ) of the beam spot B S \\ & = power density \times ( spot diameter d of the beam spot B S \div ( turning diameter D \times π \times ( turning speed N / 60 ) )\end{matrix}$$

(9) Total fluence (J/cm²): An index indicating the total energy per area given to the irradiation surface by laser irradiation from the start to the end of the process, and is expressed by the following formula.

$$\begin{matrix}Total fluence ( J / {cm}^{2} ) & = Output ( W ) \div Irradation area per second ( {cm}^{2} / s ) \times Number of irradations \\ & = Output ( W ) \div ( turning diameter D ( cm ) \times Speed of turning circle Vm ( {cm}^{2} / s ) \times Number of irradations\end{matrix}$$

The 1-point fluence described above may be deemed to be a parameter suitable for evaluating the quality of the processed surface and the amount of spatters that scatters during irradiation.

Also, the total fluence can be deemed a parameter suitable for estimating processing efficiency (evaluating processing capacity).

The setting of irradiation parameters during laser irradiation in this embodiment will be described below.

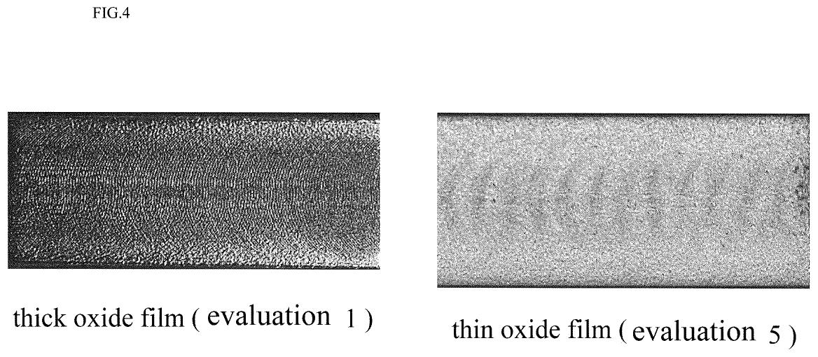

FIG. 4 is a diagram showing an example of the state of oxide film formation on the irradiated surface of the processing object after the laser irradiation processing.

An oxide film such as Fe 3 O 4 may be formed due to heat input during laser irradiation.

Such an oxide film, when it is painted for example, may affect the durability and reliability, etc. of the coating film, so it is generally preferable to suppress it.

Here, the degree of oxide film was stratified from 1 to 5 (larger number is better), and visual sensory evaluation was performed.

In FIG. 4, a photograph of evaluation 1 and a photograph of evaluation 5 are shown as examples.

In Evaluation 1, mainly blue to black oxide films are formed over a wide range with a relatively thick film thickness.

Evaluation 5 is a level where it is considered that there is no problem when painting is performed after laser irradiation treatment. Comparing to evaluation 1, it can be seen that the base steel material is exposed in a wide area, and the oxide film thickness is thin even in the region where the film is formed, accordingly the color tone and brightness are different.

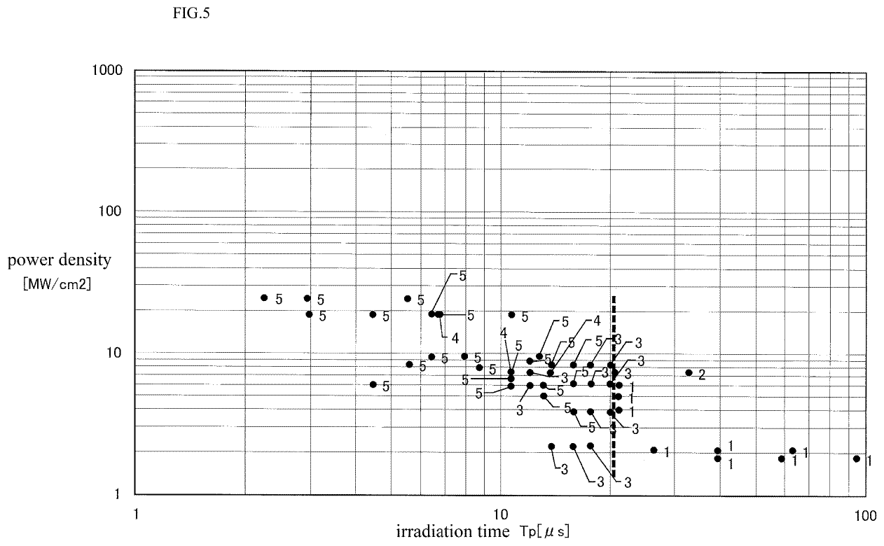

FIG. 5 is a diagram showing the correlation between irradiation time and power density, and oxide film formation.

In FIG. 5, the horizontal axis represents the irradiation time Tp of the beam spot BS when the beam spot BS passes through one point on the irradiation surface (a time length after the leading edge of the beam spot BS reaches this point until the rear edge exits out).

The vertical axis indicates the power density.

As shown in FIG. 5, at least in the region where the power density is 24 MW/cm² or less, the irradiation time is dominant in formation of the oxide film. Especially when the irradiation time is 20 μs (microseconds) or less, it can be seen that the evaluation of 3 or more is obtained with a high probability.

Therefore, in the present embodiment, the irradiation time is preferably 20 us or less, more preferably 11 us or less at which an evaluation of 4 or higher can be obtained.

Further, it is preferable to set the moving speed Vbs of the beam spot BS on the irradiation surface of the processing object O to 3 m/s or more.

This point will be described in detail below.

The relative speed (turning circle moving speed Vm) of the scanning pattern (turning circle C) is represented by the following equation.

$$Relative speed Vm scanning pattern = spot diameter d of beam spot B S \times turning speed N / 60 \times ( 1 - lap ratio )$$

A spot diameter d of the beam spot BS is represented by the following formula.

$$Spot diameter d of beam spot B S = moving speed Vbs of beam spot B S \times irradation time Tp$$

The moving speed Vbs of the beam spot BS is represented by the following formula.

$$Moving speed Vbs of beam spot B S = turning diameter D of turning circle C \times π \times turning speed N / 60$$

From these three formulas, the following formula is obtained.

$$moving speed Vbs of beam spot B S = \sqrt{\frac{\begin{matrix}relative speed Vm of the scanning pattern \times \\ turning diameter D \times π ( turning circle C )\end{matrix}}{irradation time Tp \times ( 1 - lap ratio )}} \qquad [ Formula 1 ]$$

Using this formula, the upper limit and lower limit of the moving speed Vbs of the beam spot BS were examined.

Due to restrictions on the design of the optical system, etc., the possible turning diameter D of the turning circle C is set to 10 to 200 mm, and the relative speed Vm of the turning circle C with respect to the irradiation surface (turning circle moving speed) is set to 5 to 1000 mm/s.

Assuming that the irradiation time Tp is 20 us and the lap ratio is 0, the velocity Vbs [m/s] of the beam spot BS is calculated as shown in Table 1.

TABLE 1

| | | relative speed Vm [mm/s] of the | | | | | |
|---|---|---|---|---|---|---|---|
| | | turning circle C | | | | | |
| | | (moving speed of the turning circle) | | | | | |
| | | 5 | 10 | 50 | 100 | 500 | 1000 |
| turning diameter | 10 | 3 | 4 | 9 | 13 | 28 | 40 |
| D [mm] of the | 20 | 4 | 6 | 13 | 18 | 40 | 56 |
| turning circle C | 50 | 6 | 9 | 20 | 28 | 63 | 89 |
| | 100 | 9 | 13 | 28 | 40 | 89 | 125 |
| | 200 | 13 | 18 | 40 | 56 | 125 | 177 |

When an operator carries the irradiation head 1 by hand for irradiation, the minimum value of the turning circle movement speed Vm by operating the irradiation head 1 is considered to be about 5 mm/s.

When the minimum value of the diameter D of the turning circle C in which the optical system can establish is 10 mm, the moving speed Vbs of the beam spot BS may be set to 3 m/s or more, preferably 6 m/s or more, more preferably 9 m/s or more, still more preferably 13 m/s or more.

On the other hand, when the irradiation time Tp is 1 us and the lap ratio is 0, the speed Vbs [m/s] of the beam spot BS is calculated as shown in Table 2.

TABLE 2

| | | relative speed Vm [mm/s] of the | | | | | |
|---|---|---|---|---|---|---|---|
| | | turning circle C | | | | | |
| | | (moving speed of the turning circle) | | | | | |
| | | 5 | 10 | 50 | 100 | 500 | 1000 |
| turning diameter | 10 | 13 | 18 | 40 | 56 | 125 | 177 |
| D [mm] of the | 20 | 18 | 25 | 56 | 79 | 177 | 251 |
| turning circle C | 50 | 28 | 40 | 89 | 125 | 280 | 396 |
| | 100 | 40 | 56 | 125 | 177 | 396 | 560 |
| | 200 | 56 | 79 | 177 | 251 | 560 | 793 |

When an operator carries the irradiation head 1 by hand and performs irradiation, the maximum value of the turning circle movement speed Vm by the operation of the irradiation head 1 is considered to be about 1000 mm/s.

Further, when the maximum value of the diameter D of the turning circle C in which the optical system can establish is 200 mm, the moving speed Vbs of the beam spot BS is 793 m/s or less, preferably 560 m/s or less, more preferably 396 m/s or less, still more preferably 280 m/s or less.

If the moving speed Vbs of the beam spot BS is too fast or too slow, the speed at which the operator operates the irradiation head 1, the rotation speed of the wedge prism 20, and the diameter D of the turning circle C cannot be set appropriately.

For example, when the moving speed Vbs of the beam spot BS is increased beyond the upper limit, the feed speed of the irradiation head 1 (the relative speed Vm of the turning circle C) reaches, for example, several meters per second. In this area, work is nearly difficult by holding the irradiation head 1 with hands.

In this case, in order to adjust the feeding speed of the irradiation head 1 (the relative speed Vm of the turning circle C) to be appropriate, it is necessary to reduce the rotational speed of the wedge prism 20. Although, to maintain the moving speed Vbs of the beam spot BS, it is necessary to increase the turning diameter D of the turning circle C.

For example, if the turning diameter D of the turning circle C exceeds @200 mm, it becomes difficult to design the optical system.

Conversely, when the moving speed Vbs of the beam spot BS is decreased beyond the lower limit, the feed speed of the irradiation head 1 (the relative speed Vm of the turning circle C) becomes, for example, several mm per second. In this too slow area, work is nearly difficult for the operator to manually operate.

In this case, in order to adjust the feeding speed of the irradiation head 1 (the relative speed Vm of the turning circle C) to be appropriate, it is necessary to increase the rotation speed (number of rotations N) of the wedge prism 20. Although, to maintain the velocity Vbs of the beam spot BS, it is necessary to reduce the turning diameter D of the turning circle C, and an optical system is to be configured to have a turning diameter D of several mill-meters, for example.

In addition, when it is assumed that a certain area is irradiated without omission (so that the beam spot BS passes through all points), the turning circle passing areas, which are the areas through which the turning circle C passes, are necessarily overlapped at their ends.

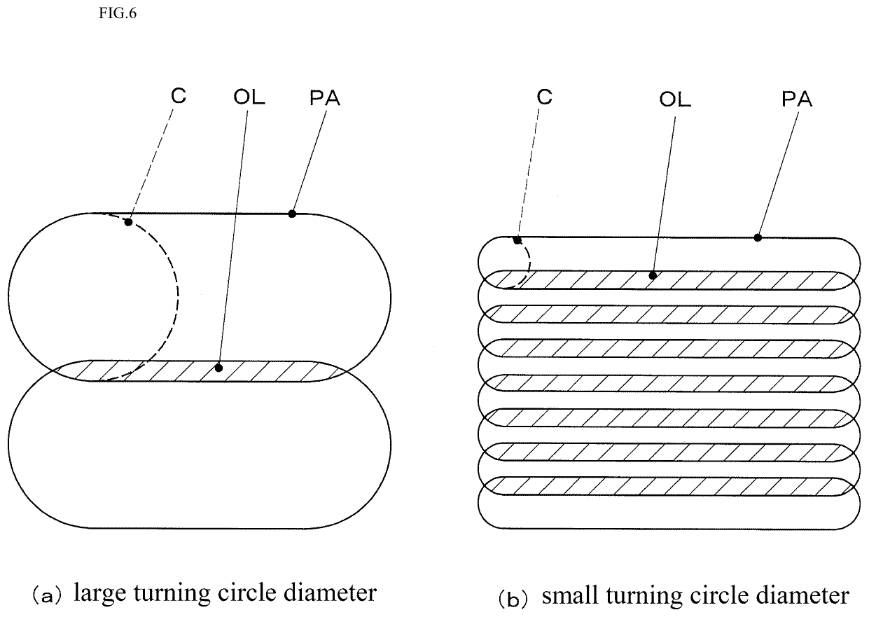

FIG. 6 is a diagram schematically showing the overlapping state of the turning circle passing areas in the embodiment.

The turning circle passing area is, except that the edge portion has an arc shape along the turning circle C, formed in a strip shape having a width in a direction perpendicular to the direction of movement of the turning circle C (scanning pattern) with respect to the irradiated surface. The width is substantially equivalent to the diameter D of the turning circle C.

FIG. 6(a) shows a state where the diameter D is relatively large, and FIG. 6(b) shows a state where the diameter D is relatively small.

An overlap OL, which is an area where both turning circle passing areas PA overlap, is provided at the boundary between the adjacent turning circle passing areas PA.

The overlapping OL is inevitable in order to irradiate the irradiation surface without omission. Although, when the overlap OL occupy an excessively large area, process efficiency and process speed are inconveniently deteriorated.

When an operator carries the irradiation head 1 by hand for irradiation, the overlap OL must be at least several millimeters.

Here, in order to perform processing efficiently, it is considered that the amount of overlap is fixed to a minimum.

As is clear from a comparison of FIGS. 6(a) and 6(b) the larger the diameter D of the turning circle C (the width of the turning circle passing area PA), the smaller the area of the overlapping OL portion (the hatched area in FIG. 6) with respect to the irradiated area. Accordingly, it is possible to reduce re-irradiation of the already-irradiated surface, which is essentially unnecessary.

Therefore, it is preferable to set the diameter D of the turning circle C to 10 mm or more, preferably 20 mm or more, and more preferably 30 mm or more.

Further, in the embodiment, in order to suppress the amount of spatters scattered from the processing object O when the laser beam B is irradiated, 1 point fluence is set.

When there is a lot of spatters, there is concern that the optical system such as the protective glass of the irradiation head 1 may be damaged.

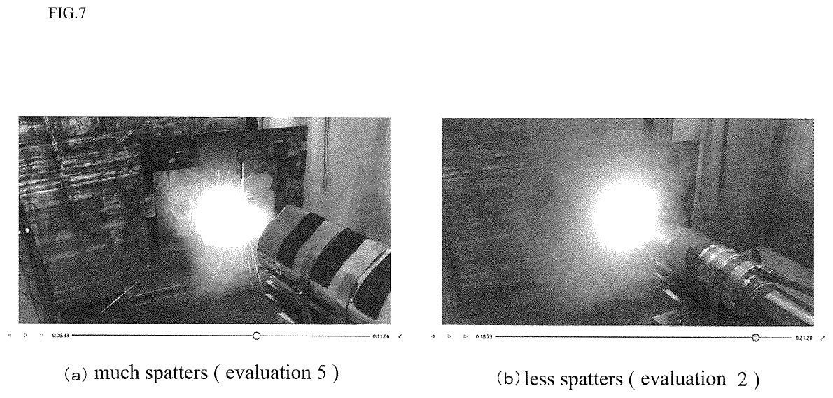

FIG. 7 is a diagram showing an example of a state in which spatters scatter during laser irradiation.

Here, the degree of spattering amount was stratified from 1 to 5 (the larger the number, the larger the spattering amount), and visual sensory evaluation was performed.

FIG. 7(a) shows a photograph of a state with much spatters (evaluation 5), and FIG. 7(b) shows a photograph of a state with less spatters compared to FIG. 7(a).

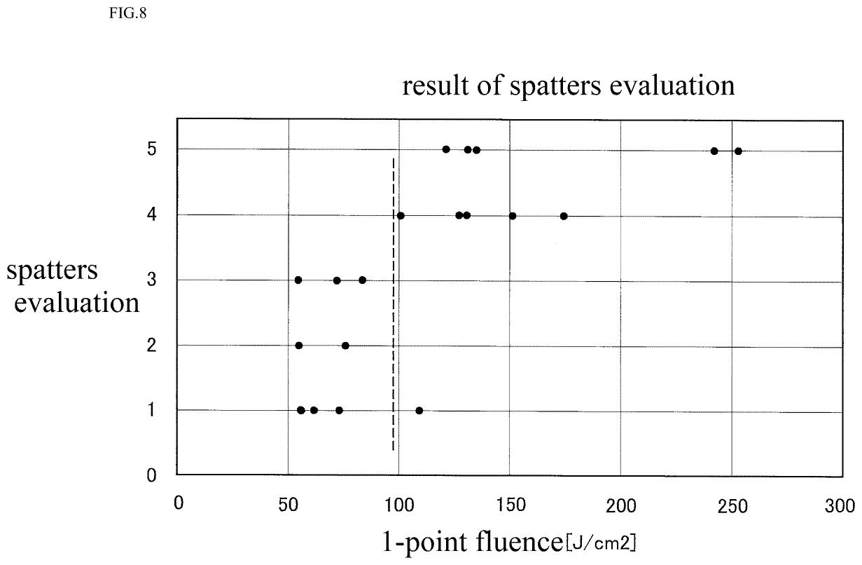

FIG. 8 is a diagram showing the correlation between the 1-point fluence and the evaluation result of the amount of spatters.

In FIG. 8, the horizontal axis indicates the 1-point fluence, and the vertical axis indicates the evaluation value of the spatters.

As shown in FIG. 8, if the 1-point fluence is 100 J/cm² or less, the evaluation value of sputtering can be 3 or less.

Therefore, in the present embodiment, it is preferable to set the 1-point fluence to 100 J/cm² or less.

In addition, when the processing object O is a structure made of iron-based metal such as steel and the purpose of surface processing is to remove rust, it is known that there is a correlation between the 1-point fluence and the amount of rust removed.

In particular, it has been found that rust cannot be removed when the 1-point fluence is too small.

Therefore, in the present embodiment, it is preferable to set the 1-point fluence to 27 J/cm² or more.

In this embodiment, it is preferable to set the fluence of one pass so that the number of passes required to complete rust removal (the number of times by the turning circle C repeatedly passes through the same location, the number of times by the irradiation circle passing area PA superimposes) is 3 passes, preferably 4 passes or more.

Experiments have shown that the rust thickness and the total fluence required to remove the rust are in a substantially proportional relationship. Therefore, if the rust thickness to be removed is known, the total fluence required for removal can be calculated.

Since the total fluence is the fluence of one pass multiplied by the number of passes (the number of repeated irradiations), the number of passes to obtain the total fluence (how many passes for completing the removal) is a designable parameter.

For example, if the fluence of 1 pass is set so that rust can be removed in 1 pass, and if rust remains (unremoved), 1 more pass irradiation shall be performed, and the irradiation time of the relevant part will be doubled.

On the other hand, by setting the fluence of 1 pass so that the removal is completed in 3 or more passes, even if 1 pass is added due to the occurrence of a residue, the irradiation time of the part will be increased from 3 passes to 4 passes. It is only about 1.3 times as large, and a decrease in process efficiency can be suppressed.

For example, when irradiation is performed for 3 passes, preferably for 4 passes, the irradiation parameters can be set so that the area of the portion where rust remains on the irradiation surface is 5% or less of the entire area.

On the other hand, if the number of passes until the removal is completed is excessively large, the process becomes complicated. Times of passes for completing rust removal is preferably under 20, more preferably under 10.

Further, in the present embodiment, it is preferable to set each of the above-described parameters, so that the surface roughness (ten-point average roughness Rz JIS defined in JIS B 0601-2001) of the surface of the processing object O immediately after the laser beam B irradiation is equal to or higher than 25 μm Rz JIS and equal to or lower than 80 μm Rz JIS. Incidentally, the measuring method of the ten-point average roughness Rz JIS is according to JIS B 0633-2001, and a small surface roughness measuring machine SURFTESTSJ-210 manufactured by Mitutoyo Co., Ltd. is used.

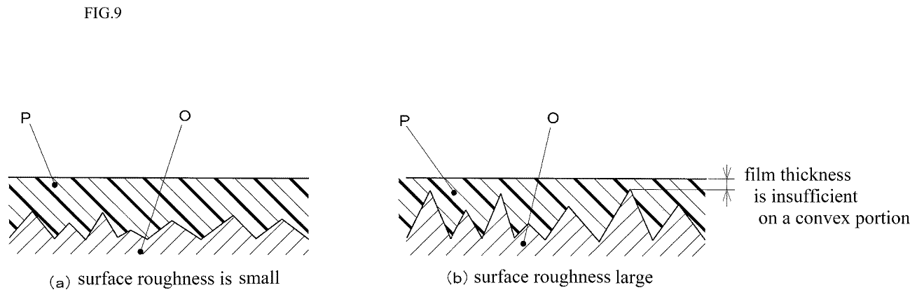

FIG. 9 is a schematic cross-sectional view of the surface of the processing object which is painted after laser irradiation.

FIG. 9(a) shows a case where the surface roughness is small, and FIG. 9(b) shows a case where the surface roughness is large.

As shown in FIG. 9, the processing object O is provided with a rugged shape due to the formation of a large number of groove-shaped irradiation marks by scanning with the beam spot BS.

By setting the surface roughness of the substrate before painting to 25 μm Rz JIS or more, an anchor effect that increases the adhesion of the painting film P between the painting film P and the processing object O is obtained, and durability and reliability of the coating film P can be ensured.

On the other hand, by setting the surface roughness of the base material before painting to 80 μm Rz JIS or less, the film thickness of the painting film P may be prevented from being locally insufficient in places where the irradiated surface of the processing object O becomes convex.

As described above, a continuous wave (CW) laser is used in this embodiment. It is practically difficult to irradiate a laser beam that satisfies the above conditions with a pulse laser.

First, generally available pulsed lasers have a pulse width of, for example, several 100 ns or less.

Next, in the removal of rust on the surface of steel materials, etc., it is known that the energy supplied in one process (the above-mentioned 1-point fluence) such as 10 J/cm², for example, is insufficient. It is considered that there is a lower limit.

This means that if one pulse should supply the energy necessary for crushing rust, the instantaneous power density would be extremely high.

However, for example, when performing process on a steel structure placed outdoors, for example, when a laser oscillator is mounted on a vehicle such as a truck and the laser is to be transmitted in a long distance to the irradiation head (for example, several tens of meters or longer), the generation of Raman scattered light limits the power density.

On the other hand, as a method to transmit high energy while lowering the power density, it is necessary to enlarge (thicken) the core diameter of the fiber.

However, in this case, it is necessary to configure an optical system for reducing the spot diameter d of the beam spot BS projected from the irradiation head 1 onto the processing object. Although, it is difficult to secure a working distance. Also, the arrangement of an optical system for rotational scanning is difficult.

Therefore, it is practically difficult to use a pulsed laser, and it is necessary to use a continuous wave laser.

Next, the relationship between the 1-point fluence and the formation of an oxide film was examined in more detail.

As described above, when the irradiation time Tp is set to 20 us or less, formation of an oxide film can be effectively prevented under many irradiation conditions.

However, it is known that when the 1-point fluence is excessively small, an oxide film may be formed even when the irradiation time Tp is set to 20 us or less.

Therefore, for SS400, which is a general structural rolled steel material, an additional experiment was performed in which laser irradiation was performed in a region where the 1-point fluence was lower than the data shown in FIG. 5, and the formation state of the oxide film was confirmed.

In normal process, irradiation is stopped when the rust is removed by irradiating the laser beam. Therefore, in the experiment in which the data shown in FIG. 5 has been acquired, irradiation is stopped when the most of rust is removed or rust is completely removed, and then the irradiation surface is visually evaluated.

On the other hand, in the additional experiment, especially under the condition where the 1-point fluence was low, the state of the oxide film changed according to the increase in the number of passes, so irradiation was continued until the state of the oxide film stabilized. Therefore, the number of times of irradiation tends to increase compared to the former experiment.

In an additional experiment, an SS400 grid-blasted steel plate (size 70 mm×150 mm×t 6 mm, rust removal degree 2.0) was irradiated multiple times.

The rust removal degree is stipulated in JISZ 0310 “General Rules for Blasting Methods for Substrate Conditioning”.

Incidentally, although this technology was originally intended to remove deposits such as rust, the additional experiment was focused on the state of formation of the oxide film, accordingly, irradiation was performed in a state where there was no rust or the like on the irradiated surface.

At this time, the 1-point fluence and the irradiation time were changed as parameters.

The degree of the oxide film on the irradiated surface was visually evaluated by sensory evaluation.

The 1-point fluence and irradiation time, which are the parameters to be changed, were adjusted by the output of the laser oscillator and the defocus of the beam spot (the distance of the focal point from the irradiation surface).

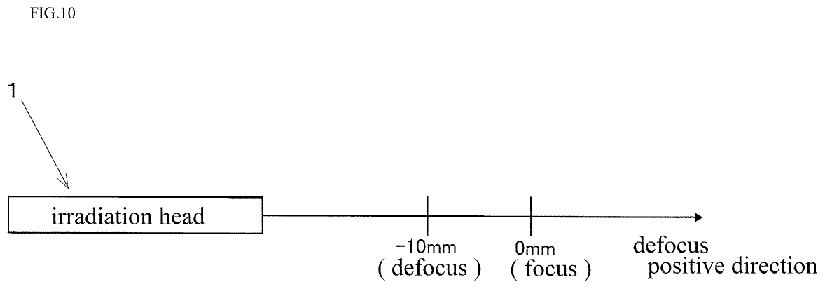

FIG. 10 is a diagram showing the definition of defocus during laser irradiation.

As shown in FIG. 10, a direction of defocus is defined as a positive direction in which the direction of the irradiation surface aparts from the irradiation head, with the focus position being the origin (0).

The number of irradiation times (the number of passes) was set, by visually confirming the condition of the irradiated surface, so that the degree of the formed oxide film ceased to change substantially.

Further, the oxide film evaluation values shown in FIG. 4 etc. will be described in more detail.

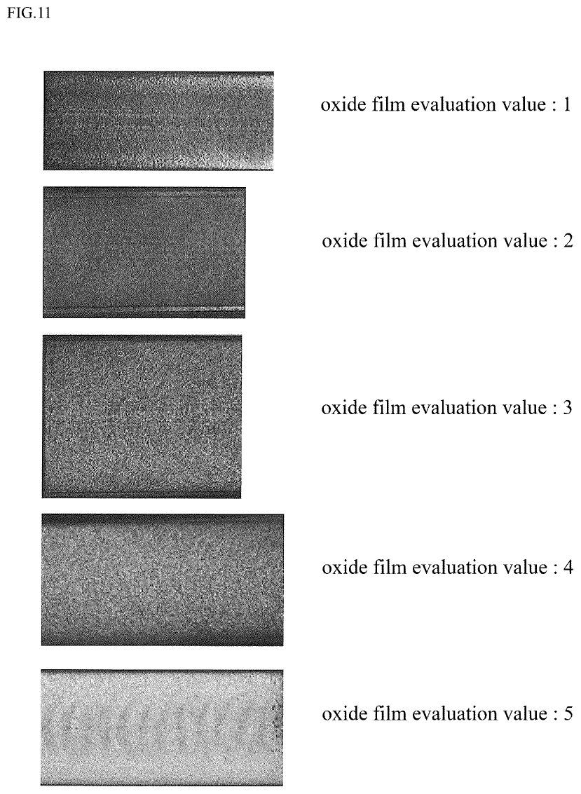

FIG. 11 is a diagram showing an example of the state of oxide film formation on the irradiated surface of the processing object after laser irradiation processing, and is obtained by adding evaluation values 2 to 4 to the data in FIG. 4.

In the evaluation of the oxide film, evaluation values 1 (poor) to 5 (good) are set based on the following three viewpoints.
(1) Area (%) of relatively thick blue to black oxide film
(2) Distribution mode of bluish to blackish oxide film (existing position, state of irradiation range end (edge), degree of scattering, etc.)
(3) Overall color tone due to relatively thin oxide film

Specifically, the evaluation values 1 to 3 are defined by the ratio of the area of the relatively thick blue to black oxide film (a small area is good), and the evaluation values 4 to 5 are defined, in addition to the area, by the overall color tone (the less discoloration from the metal base color, the better).

With an oxide film evaluation value of 1, the area of bluish to blackish portions indicating a relatively thick oxide film exceeds 30%.

With an oxide film evaluation value of 2, the area of the bluish to blackish portion exceeds 20%.

With an oxide film evaluation value of 3, the area of the bluish to blackish portion is less than 20%, and the bluish to blackish portion is scattered in the edge portion of the irradiation range, or, the bluish to blackish portion tend to remain in a scattered state in the region other than the edge portion (not totally spread state).

With an oxide film evaluation value of 4, the area of bluish to blackish portions is less than 10%, and the overall color tends to exhibit yellowish discoloration (indicating a relatively thin oxide film).

With an oxide film evaluation value of 5, the area of the blue to black portion is less than 10%, and the overall color tend to exhibit a silver (metallic ground color) to a color changing from silver to pale yellow (indicating a relatively thin oxide film).

Table 3 is a table showing the correlation between the 1-point fluence and the oxide film evaluation value in the additional experiment, and shows the state after two passes of laser light irradiation.

The state at this time simulates the state in which the irradiation is stopped at the point when the removal of deposits such as rust is completed (immediately after the removal is completed) in the process of removing deposits such as rust.

TABLE 3
1-point fluence and oxide film evaluation value 2 passes

| | Conditions | | | | |
|---|---|---|---|---|---|
| | Output | Defocus | Irradiation | 1-point fluence | Evaluation |
| Number | [W] | [mm] | time [μs] | [J/cm²] | value |
| 1 | 5500 | −10 | 15 | 49 | 5 |
| 2 | 4500 | −10 | 15 | 40 | 5 |
| 3 | 2500 | −2 | 9 | 35 | 4 |
| 4 | 3500 | −10 | 15 | 31 | 4 |
| 5 | 2000 | −2 | 9 | 27 | 3 |
| 6 | 2500 | −10 | 15 | 22 | 3 |
| 7 | 1500 | −2 | 9 | 21 | 3 |
| 8 | 2000 | −10 | 15 | 18 | 3 |

Table 4 is a table showing the correlation between the 1-point fluence and the oxide film evaluation value in the additional experiment, and shows the state at the end of the laser beam irradiation (when there is no change in the formation of the oxide film observed).

The state at this time simulates a case in which additional irradiation is performed after the completion of removal of deposits in the process of removing deposits such as rust.

TABLE 4
1-point fluence and oxide film evaluation value final state

| | Conditions | | | | |
|---|---|---|---|---|---|
| | Output | Defocus | Irradiation | 1-point fluence | Evaluation |
| Number | [W] | [mm] | time [μs] | [J/cm²] | value |
| 1 | 5500 | −10 | 15 | 49 | 5 |
| 2 | 4500 | −10 | 15 | 40 | 5 |
| 3 | 2500 | −2 | 9 | 35 | 4 |
| 4 | 3500 | −10 | 15 | 31 | 4 |
| 5 | 2000 | −2 | 9 | 27 | 3 |
| 6 | 2500 | −10 | 15 | 22 | 1 |
| 7 | 1500 | −2 | 9 | 21 | 1 |
| 8 | 2000 | −10 | 15 | 18 | 1 |

As shown in Tables 3 and 4, under the conditions ( ) of numbers 6 to 8 where the 1-point fluence is 18 to 22, the evaluation value is 3 during two-pass irradiation. Although, after that, when irradiation is performed until the formation of the oxide film stabilizes, at this stage, an oxide film is formed and grows and the evaluation value deteriorates to 1 at the end of the irradiation.

That is, under the conditions of numbers 6 to 8, since the evaluation value is 3 during two-pass irradiation, if the irradiation is stopped at this point, and when evaluation values of 3 or more are allowed, the result is allowed. However, if irradiation is continued after that, the oxide film shall get worse beyond the allowable range.

Even when the laser beam is excessively irradiated after the rust removal is completed, the formation of a bluish to blackish oxide film that covers the entire irradiation surface should be suppressed and should be improved within the extent that black oxide films are scattered (evaluation value is 3 or more). For that, it is preferable to set the 1-point fluence to 27 J/cm 2 or more.

In addition, even if the laser beam is excessively irradiated after the rust removal is completed, the area of the scattered blue to black oxide film should be improved so that it becomes smaller (an evaluation value of 4 or more). For that, it is preferable to set the 1-point fluence to 31 J/cm 2 or more.

As described above, according to this embodiment, the following effects can be obtained.

(1) The formation of an oxide film can be effectively suppressed by setting the local irradiation time Tp to 20 us or less for one point on the irradiated irradiation surface during one passage of the beam spot BS.

Further, by moving the beam spot BS formed by the continuous-wave laser light to the irradiation surface so that the relative velocity Vbs to the irradiation surface is 3 m/s or more, it is possible to improve process quality by preventing the fluence in the irradiated surface from becoming excessively high within the output of the laser oscillator required in a practical process, and the time required for the beam spot BS to scan the unit area (process time) can be shortened.

(2) By rotating the beam spot BS on the irradiation surface along the turning circle C and moving the turning center relative to the irradiation surface, and by adjusting the diameter D of the turning circle C and the number of rotations N (rotation speed of the wedge prism 20) of the beam spot BS, the irradiation time Tp and the speed Vbs of the beam spot BS can be appropriately set.

Also, the beam spot BS can be easily scanned over a wide area.

(3) By setting the turning diameter D of the beam spot BS to 10 mm or more, it is possible to prevent the process efficiency from deteriorating due to an increase in the area of the overlap OL with respect to the total area.

(4) By setting the fluence so that the number of passes required to remove rust at 3 passes, preferably 4 passes or more, if rust etc. remain and one additional pass irradiation is performed, additional extension of process time due to irradiation can be suppressed.

(5) By setting the fluence so that the number of passes required to remove rust is 20 passes, preferably 10 passes or less, there is no need to repeat irradiation excessively, and complication of the process can be suppressed.

(6) By setting the 1-point fluence to 100 J/cm² or less, it is possible to suppress the generation of spatters and other scattered matter, and protect the protective glass 30 of the irradiation head 1 and other optical systems.

(7) By setting the 1-point fluence to 27 J/cm² or more, rust can be reliably crushed and removed.

Further, even when the laser beam is further irradiated after finishing the rust removal, it is possible to suppress formation of a bluish to blackish oxide film over a wide range of the irradiation surface.

Further, more preferably, when the 1-point fluence is 31 J/cm² or more, even when the laser beam is further irradiated after the rust removal is completed, the blue to black oxide film can be suppressed from being formed in scattered state on the irradiated surface.

(8) By setting the surface roughness of the irradiated surface to 25 μm Rz JIS or more after irradiation with the laser beam, an anchor effect can be generated between the surface and the paint film, and the adhesion of the paint film can be improved.

(9) By setting the surface roughness of the irradiated surface after laser irradiation to 80 μm Rz JIS or less, the film thickness of the paint film on the convex portions of the uneven shape of the irradiated surface is prevented from becoming insufficient, thus ensuring the painting quality.

### Modification

The present invention is not limited to the embodiments described above, and various modifications and changes are possible, which are also within the technical scope of the present invention.

The surface processing method and the configuration of the laser irradiation apparatus for performing this are not limited to the above-described embodiments, and can be changed as appropriate.

For example, the method for scanning the irradiation surface with the beam spot is not limited to rotating the wedge prism as in the embodiment, and other methods such as a galvanometer scanner or a polygon mirror may be used. Also, the scanning pattern of the beam spot is not limited to the swirl circle as in the embodiment, and can be appropriately changed to, for example, a polygonal shape or other shapes.

Further, the irradiation parameters shown in the embodiment are only examples, and the irradiation parameters can be changed as appropriate without departing from the technical scope of the present invention.

Further, the material of the object to be irradiated, the object to be removed on the surface thereof, the purpose of the surface processing, etc. are not particularly limited.

[Explanation of letters or numerals]

| | | | |
|---|---|---|---|
| 1 | irradiation head | 10 | focus lens |
| 20 | wedge prism | 30 | protective glass |
| 40 | rotary cylinder | 50 | motor |
| 60 | motor holder | 61 | purge gas passage |
| 70 | protective glass holder | 80 | housing |
| 90 | duct | 91 | inner cylinder |
| 91a | small diameter portion | 91b | tapered portion |
| 92 | outer cylinder | 92a | small diameter portion |
| 92b | end | 93 | dust collector connection |
| | | | cylinder |
| B | laser beam | BS | beam spot |
| d | beam spot diameter | O | processing object |
| C | irradiation circle | D | irradiation circle diameter |
| PA | turning circle passing area | OL | overlap |

1. A surface processing method for removing a surface of a processing object by moving a beam spot with respect to the processing surface, the beam spot being formed by condensing a continuous wave laser beam on an irradiation surface of the processing object,
an irradiation time length is 20 μ-second or less when the beam spot passes through one point on the irradiation surface, wherein
a relative speed of the beam spot to the irradiation surface is 3 m/s or more.

2. The surface processing method according to claim 1, wherein
while the beam spot is circulated along a predetermined scanning pattern on the irradiation surface, the scanning pattern is moved relative to the irradiation surface.

3. The surface processing method according to claim 2, wherein
the scanning pattern is circumferential and
the beam spot is rotated along the circumference.

4. The surface processing method according to claim 2, wherein,
when the scanning pattern is relatively moved with respect to the irradiation surface, width of the scanning pattern perpendicular to a direction of relative movement is 10 mm or more.

5. The surface processing method according to claim 2, wherein,
when number of passes, which is number of times that the scanning pattern is repeatedly moved along the irradiation surface so that a same region of the irradiation surface is irradiated in a superimposed state, is set to 3 or more, an energy to be applied to the irradiation surface is set so that an area on which objects to be removed remain is 5% or less of the entire surface on the irradiation surface.

6. The surface processing method according to claim 2, wherein,
when number of passes, which is number of times that the scanning pattern is repeatedly moved along the irradiation surface so that the same region of the irradiation surface is irradiated in a superimposed state, is set to 20 or less, an energy to be applied to the irradiation surface is set so that the area on which objects to be removed remain is 5% or less of the entire surface on the irradiation surface.

7. The surface processing method according to claim 1, wherein
1-point fluence, which is energy per unit area applied to the irradiation surface when the beam spot passes through one point on the irradiation surface, is set to 100 J/cm² or less.

8. The surface processing method according to claim 1, wherein
1-point fluence, which is energy per unit area applied to the irradiation surface when the beam spot passes through one point on the irradiation surface, is set to 27 J/cm² or more.

9. The surface processing method according to claim 1, wherein
1-point fluence, which is energy per unit area applied to the irradiation surface when the beam spot passes through one point on the irradiation surface, is set to 31 J/cm² or more.

10. The surface processing method according to claim 1, wherein
the surface roughness of the irradiation surface after irradiation with the laser beam is set to 25 μm Rz JIS or more.

11. The surface processing method according to claim 1, wherein
the surface roughness of the irradiation surface after irradiation with the laser beam is set to 80 μm Rz JIS or less.

12. The surface processing method according to claim 1, wherein
the base material of the processing object is made of an iron-based metal.

13. The surface processing method according to claim 1, wherein
the surface removed from the processing object by irradiation with the laser beam comprises at least one of an oxide, hydroxide, carbonate, paint film or salinity of the base material of the processing object or a material of a paint film formed on the surface of the base material.
